(19) United States
(12) Patent Application Publication
(10) Pub. No.: US 2013/0173393 A1
(43) Pub. Date: Jul. 4, 2013

(54) CUSTOMIZING OFFERS BASED ON THE OPPORTUNITY COST OF THE USER

(71) Applicants: Matthew A. Calman, Charlotte, NC (US); Erik Stephen Ross, Charlotte, NC (US)

(72) Inventors: Matthew A. Calman, Charlotte, NC (US); Erik Stephen Ross, Charlotte, NC (US)

(73) Assignee: BANK OF AMERICA CORPORATION, Charlotte, NC (US)

(21) Appl. No.: 13/342,078

(22) Filed: Jan. 1, 2012

(51) Int. Cl. G06Q 30/02

(52) U.S. Cl. 705/14.66

(57) ABSTRACT

Embodiments of the present invention relate to systems, apparatus, methods and computer program products for providing users customized offers that reflect the user's opportunity cost associated with accepting the offer. In this regard, the customized offers may include additional savings, in terms of an additional discount, percentage-off or other incentive, to account for the user's specific transportation costs, time costs and the like. In additional embodiments the customization accounts for the user's propensity for accepting offers and adjusts the offer discount, percentage-off or other incentive based on their historical acceptance rates. By customizing the offers to account for opportunity costs, and in some embodiments historical offer acceptance rates, the present invention serves to increase offer acceptance, thereby benefiting the program provider and/or the merchants offering the offers/deals.

### FIELD

In general, embodiments of the invention relate to commerce and, more particularly, providing users customized offers based on the opportunity cost associated with the user accepting the offer.

### BACKGROUND

Many Internet-based offer or deal sites, such as Groupon™ and LivingSocial™ have recently flourished; however, such sites are generally limited to providing offers or deals that are of a generic nature. While participants in such deal programs may limit the deals that they are offered by geographic regions and/or product/service-type, each participant that chooses a geographic region and/or product/service-type receives the same offer/deal as any other participant.

The current deal/offer models do not account for the opportunity cost incurred by the user in accepting an offer. Opportunity cost is traditionally defined as the loss of potential gain from other alternatives when one alternative is chosen. In the realm of deals/offers, the opportunity cost includes costs incurred by the participant in choosing the offer versus choosing another alternative. For example, if a participant typically frequents a specific merchant, an offer/deal associated with a different merchant may cause the participant to incur additional transportation costs (e.g., fuel costs or the like), as well as additional time, in order to accept the offer. In another example, if a participant typically travels along a routine travel pattern (e.g. a daily commute pattern), an offer/deal associated with a merchant located such that the participant would have to deviate from the routine travel pattern would cause the participant to incur additional transportation costs (e.g., fuel costs or the like), as well as additional time, in order to accept the offer. The additional transportation costs, costs related to the additional time and any other costs sustained by the participant in accepting the offer are what are referred to as the opportunity cost. As the examples point out, the opportunity costs will vary from participant-to-participant depending upon the level of deviation required by the specific participant in accepting the offer.

Therefore, a need exists to provide offers and deals that may be customized for each program participant. In this regard, the desired customization should provide for offer customization (i.e., varying the discount amount, the percentage off or the like based on a participant specific attribute). More specifically, the desired offer customization should be able to account for the opportunity cost incurred by specific users/participants in accepting the offers.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for providing users customized offers based on the user's opportunity cost associated with accepting the offer.

The present invention is based on the premise that, in most instances, a customer incurs an opportunity cost when accepting an offer. These opportunity costs may include, but are not limited to, transportation costs (e.g., fuel cost, public transportation costs, etc.), time costs and the like. For example, if the user must deviate from their normal travel pattern (e.g., a daily commute pattern) in order to travel to a merchant associated with the offer, the user incurs an additional travel cost (e.g., a fuel cost or a public transportation cost) and incurs a cost associated with the additional time. In this regard, the travel cost and the time cost form at least a part of the customer's opportunity cost.

In this regard, each user is provided with an offer that may vary in terms of the discount, percentage-off or the like based on the specific costs that a user will incur by accepting the offer. For example, users that will incur greater opportunity costs (e.g., greater fuel costs by travelling a further distance to the merchant associated with the offer) will be provided a higher discount, percentage-off or other incentive than users that incur less opportunity costs.

In addition to customizing offers based on opportunity cost, the present invention additionally provides for customizing or optimizing offers based on the user's offer acceptance rate. Such, customization/optimization is based on the premise that users who are more willing to accept offers will accept less in terms of the discount/incentive than users who are less willing to accept offers. For example, users that have historically shown a greater propensity to accept offers may be provided a lesser discount, percentage-off or other incentive than users that that have shown a lesser propensity to accept offers.

A method for providing merchant offers defines first embodiments of the invention. The method includes determining one or more costs associated with a user accepting a merchant offer, generating the merchant offer that is user-specific based on the determined costs and communicating the merchant offer to the user.

In specific embodiments of the method, determining further includes determining at least one of a transportation cost or a time cost associated with the user accepting the merchant offer. In such embodiments the generated merchant offer reflects savings fluctuations based on the transportation cost and/or time cost.

In other specific embodiments of the method, determining further includes determining a first merchant that is routinely frequented by the user, determining a distance between the first merchant and a second merchant associated with the merchant offer and determining one or more of a fuel cost, a public transportation cost or a travel time cost associated with the distance. In such embodiments of the method, the generated merchant offer reflects savings fluctuations based on the fuel costs, the public transportation cost and/or the travel time cost. In such embodiments of the method, determining the first merchant may further include determining the first merchant based on historical financial transaction data associated with the user. Further in such embodiments, determining the fuel cost may further include determining the fuel costs based on fuel efficiency of a vehicle driven by the user.

In still further specific embodiments of the method, determining further includes determining a routine travel pattern associated with the user and determining, via a computing device, one or more of a fuel cost, a public transportation cost or a travel time cost associated with the user deviating from the routine travel pattern. In such embodiments of the method, the generated merchant offer reflects savings fluctuations based on the fuel cost, the public transportation cost and/or the travel time cost. In such embodiments of the method, determining the routine travel pattern may further include determining the routine travel pattern based on financial transaction data associated with the user and, in addition, based on location data associated with the user. In still further such embodiments of the method, determining one or more further includes determining a distance between a merchant associated with the merchant offer and a point along the routine travel pattern and determining the fuel cost, the public transportation cost or the travel time cost associated with the distance.

Additionally, in other specific embodiments of the method, the merchant offer is specific to a time period and one of the costs is associated with the user accepting the merchant offer in lieu of another event planned by the user during the time period. In such embodiments the method may further include determining the event based on accessing one or more of an electronic event calendar associated with the user, travel itineraries associated with the user, a social network site associated with the user or historical electronic media usage data associated with the user.

In still further embodiments of the method, generating further includes generating an optimal user-specific merchant offer that is optimized based at least in part on the determined costs. In such embodiments of the method, the optimal user-specific merchant offer may be defined as a lowest percentage off or a lowest currency amount off that result in the user accepting the merchant offer. In such embodiments of the method, generating the optimal user-specific merchant offer may further include generating the optimal user-specific merchant offer based on a historical offer acceptance rate of the user.

An apparatus for providing merchant offers provides for second embodiments of the invention. The apparatus includes one or more computing devices including a memory and at least one processor in communication with the memory. The apparatus further includes an opportunity cost module stored in the memory, executable by the processor and configured to determine one or more costs associated with a user accepting a merchant offer. In addition, the apparatus includes a merchant offer module stored in the memory, executable by the processor and configured to generate the merchant offer that is user-specific based on the determined costs and initiate communication of the merchant offer to the user.

In specific embodiments of the invention the opportunity cost module is further configured to determine at least one of a transportation cost or a time cost associated with the user accepting the merchant offer. In such embodiments, the merchant offer module is configured to generate the merchant offer that reflects user-specific savings fluctuations based on the fuel cost, the public transportation cost and/or the travel time cost.

In still further specific embodiments of the apparatus, the opportunity cost module includes a similar merchant routine configured to determine a first merchant that is routinely frequented by the user and is similar to a second merchant associated with the merchant offer. In addition, the opportunity cost module includes a distance routine configured to determine a distance between the first merchant and the second merchant and an opportunity cost routine configured to determine one or more of a fuel cost, a public transportation cost or a travel time cost associated with the distance. In such embodiments of the apparatus, the similar merchant routine is further configured to determine the first merchant based on historical financial transaction data associated with the user. In further such embodiments, the opportunity cost routine is further configured to determine the fuel costs based on fuel efficiency of a vehicle driven by the user.

In other specific embodiments of the apparatus, the opportunity cost module further includes a travel pattern routine configured to determine a routine travel pattern associated with the user and an opportunity cost routine configured to determine one or more of a fuel cost, a public transportation cost or a travel time cost associated with the user deviating from the routine travel pattern. In such embodiments of the apparatus, the travel pattern routine is further configured to determine the routine travel pattern based on financial transaction data associated with the user and, in some embodiments, based on location data associated with the user. In other such embodiments of the apparatus, the opportunity cost routine is further configured to determine a distance between a merchant associated with the merchant offer and a point along the routine travel pattern and determine the fuel cost, the public transportation cost or the travel time cost associated with the distance.

Moreover, in further embodiments of the apparatus, in which the merchant offer is specific to a time period and one of the costs is associated with the user accepting the merchant offer in lieu of another event planned by the user during the time period, the opportunity module may include event determining routine configured to determine the event based on accessing one or more of an electronic event calendar associated with the user, travel itineraries associated with the user, a social network site associated with the user or historical electronic media usage data associated with the user.

In still further related embodiments of the apparatus, the merchant offer module further includes an offer optimization routine configured to optimize the user-specific merchant offer based at least in part on the determined costs. In such embodiments of the apparatus, the offer optimization routine is further configured to optimize the user-specific merchant offer based on a lowest percentage off or a lowest currency amount off that result in the user accepting the merchant offer. In still further such embodiments, the offer optimization routine is further configured to optimize the user-specific merchant offer based on a historical offer acceptance rate of the user.

A computer program product defines third embodiments of the invention. The computer program product includes a non-transitory computer-readable medium having computer-executable instructions. The instructions cause a computer to implement the steps of determining one or more costs associated with a user accepting a merchant offer, generating the merchant offer that is user-specific based on the determined costs; and communicating the merchant offer to the user.

Thus, further details are provided below for systems, apparatus, methods and computer program products for providing users customized offers that reflect the user's opportunity cost associated with accepting the offer. In this regard, the customized offers may include additional savings, in terms of an additional discount, percentage-off or other incentive, to account for the user's specific transportation costs, time costs and the like. In additional embodiments the customization accounts for the user's propensity for accepting offers and adjusts the offer discount, percentage-off or other incentive based on their historical acceptance rates. By customizing the offers to account for opportunity costs, and in some embodiments historical offer acceptance rates, the present invention serves to increase offer acceptance, thereby benefiting the program provider and/or the merchants offering the offers/deals.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Reference will now be made to the accompanying drawings, which are not necessarily drawn to scale, and wherein:

FIG. 1 is a block diagram of an apparatus for generating merchant offers that take into account a user's opportunity cost associated with accepting the offer, in accordance with an embodiment of the present invention;

FIG. 2 is a block diagram of an opportunity cost module for determining a user's opportunity cost associated with accepting a merchant offer, in accordance with embodiments of the present invention;

FIG. 3 is a block diagram of an alternate opportunity cost module for determining a user's opportunity cost associated with accepting a merchant offer, in accordance with embodiments of the present invention;

FIG. 4 is a block diagram of another alternate opportunity cost module for determining a user's opportunity cost associated with accepting a merchant offer, in accordance with embodiments of the present invention;

FIG. 5 is a block diagram of a merchant offer module including an offer optimization routine, in accordance with embodiments of the present invention; and

FIG. 6 is a flow diagram of a method for generating user-specific merchant offers that take into account a user's opportunity cost associated with accepting the offer, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident, however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments of the present invention, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

In general, embodiments of the present invention relate to systems, methods and computer program products for providing users customized offers based on the user's opportunity cost associated with accepting the offer. In most instances, a customer incurs an opportunity cost when accepting an offer. These opportunity costs may include, but are not limited to, transportation costs (e.g., fuel cost, public transportation costs, etc.), time costs and the like. For example, if the user must deviate from their normal travel pattern (e.g., a daily commute pattern) in order to travel to a merchant associated with the offer, the user incurs an additional travel cost (e.g., a fuel cost or a public transportation cost) and incurs a cost associated with the additional time needed to travel to the merchant associated with the offer. In this regard, the travel part cost is included in the customer's opportunity cost.

According to embodiments of the invention, each user is provided with an offer that may vary in terms of the discount, percentage-off or the like based on the specific costs that a user will incur by accepting the offer. For example, users that will incur greater opportunity costs (e.g., greater fuel costs by travelling a further distance to the merchant associated with the offer, greater time cost due to the time incurred travelling to the merchant and the like) will be provided a higher discount, percentage-off or other incentive than users that incur less opportunity costs.

In addition to customizing offers based on opportunity cost, the present invention additionally provides for customizing or optimizing offers based on the user's offer acceptance rate. Such, customization/optimization is based on the premise that users who are more willing to accept offers will accept less in terms of the discount/incentive than users who are less willing to accept offers. For example, users that have historically shown a greater propensity to accept offers may be provided a lesser discount, percentage-off or other incentive than users that that have shown a lesser propensity to accept offers.

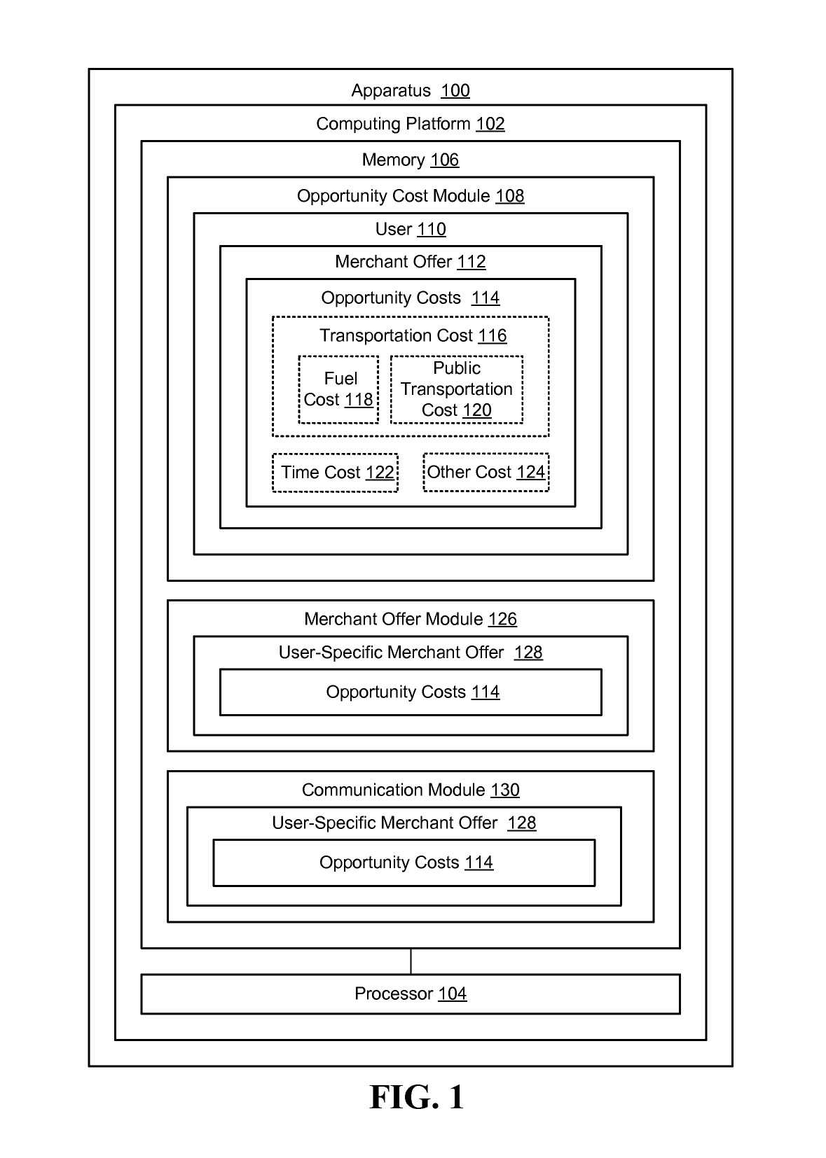

Referring to FIG. 1 a block diagram is depicted of an apparatus 100 configured to provide for generating merchant offers that take into account a user's (i.e., a customer's) opportunity cost associated with accepting an offer. The apparatus 100 includes a computing platform 102 having a memory 106 and at least one processor 104 in communication with the memory. The apparatus 100 may include any type and/or combination of one or more computing devices, such as servers, personal computers, or the like. The computing platform 102 is operable to receive and execute modules, routines and applications, such as opportunity cost module 108, merchant offer module 122, communication module 126 and the like. Memory 106 may comprise volatile and nonvolatile memory such as read-only and/or random-access memory (RAM and ROM), EPROM, EEPROM, flash cards, or any memory common to computing platforms. Further, memory 106 may include one or more flash memory cells, or may be any secondary or tertiary storage device, such as magnetic media, optical media, tape, or soft or hard disk.

Further, computing platform 102 also includes processor 104, which may be an application-specific integrated circuit (“ASIC”), or other chipset, processor, logic circuit, or other data processing device. Processor 104 or another processor such as an ASIC may execute an application programming interface (“API”) layer (not shown in FIG. 1) that interfaces with any resident programs, such as opportunity cost module 108, merchant offer module 122, communication module 126 or the like, stored in the memory 106 of apparatus 102. Processor 104 may include various processing subsystems (not shown in FIG. 1) embodied in hardware, firmware, software, and combinations thereof, that enable the functionality of apparatus 100 and the operability of the apparatus on a network. For example, processing subsystems allow for initiating and maintaining communications, and exchanging data, with other networked devices. It should be noted that any of the modules, sub-modules, and routines shown and described as being stored in memory 106 may alternatively be embodied in processing subsystems.

Memory 106 of apparatus 100 stores opportunity cost module 108, which is executable by processor 104 and configured to determine a user's 110 opportunity cost(s) 114 associated with accepting a merchant's offer 112. It should be noted that an opportunity cost 110 is specific to both the merchant offer 112 and the user 110 and, as such, opportunity cost will vary from user-to-user and from offer-to-offer. The opportunity costs 114 may include transportation costs 116 required for the user 110 to travel to the merchant providing the offer 112. These transportation costs may include, but are not necessarily limited to, fuel costs 118 and/or public transportation 120 costs. In addition, the opportunity costs 114 may include a time cost 122, which accounts for the time to acquire the offer, e.g., the time spent travelling to the merchant and/or the time to redeem an acquired offer 112. In other embodiments of the invention, the opportunity cost module 108 may be configured to determine other opportunity costs 124, which a user 110 may be subject to incurring when accepting a merchant offer 112.

In addition, memory 106 of apparatus 100 stores merchant offer module 126 that is configured to generate user-specific merchant offers 128 based on the determined opportunity costs 114. As such, merchant offers 128 generated for the user 110 will include additional benefits, such as additional discounts (e.g., additional percentage-off or dollar amount-off) or additional redemption value, based on the determined opportunity costs 114. For example, if a first user incurs $5.00 (five dollars) in opportunity cost, the user-specific merchant offer generated for the first user may provide for a 12 percent discount (e.g., a 10 percent baseline discount plus an additional 2 percent to account for the opportunity cost). However, if a second user incurs $1.00 (one dollar) in opportunity cost, the user-specific merchant offer generated for the second user may provide for a 10.5 percent discount (e.g., a 10 percent baseline discount plus an additional 0.5 percent to account for the opportunity cost). The generated user-specific offer 128 may be configured such that user is made aware that the offer includes an additional benefit associated with the user's specific opportunity costs (i.e., the offer provides for a breakdown) or the user-specific offer 128 may be configured such that the user is unaware that offers includes an additional benefit associated with the user's opportunity costs.

It should be noted that the merchant offer 112 and the resulting user-specific merchant offer 128 may be a targeted offer specifically targeted for that particular user. The term “targeted offer” refers to any offer that is targeted for a user based on the user's actual or perceived needs, desires or the like. In specific embodiments of the invention, financial transaction data, such as credit card/debit card purchase data or the like, may be used to determine a user's actual or perceived needs, actual or perceived interests and the like. Such information is then used to determine which offer to provide to the user, resulting in targeted offers. In accordance with embodiments of the present invention, these targeted merchants offers may include user-specific merchant offers 128 which take into account the users' determined opportunity costs 114. In other embodiments of the invention the merchant offer 112 and the resulting user-specific merchant offer 128 may be non-targeted offers that are typically offered to an entire population.

Memory 106 of apparatus 100 additionally stored communication module 130, which is executable by the processor 104 and configured to initiate electronic communication of the user-specific merchant offer 128 to the user 110. The communication module 130 may be configured to send the user-specific merchant offer 128 via electronic mail (i.e., email), short message service (SMS)/text or the like. In certain embodiments the user 110 may be a participant in a merchant offer program. In such programs the user 110 may pre-configure the program in terms of the types of merchant offers they prefer, the frequency of receiving the offers, the communication mechanism (e.g., email and/or text) and the like.

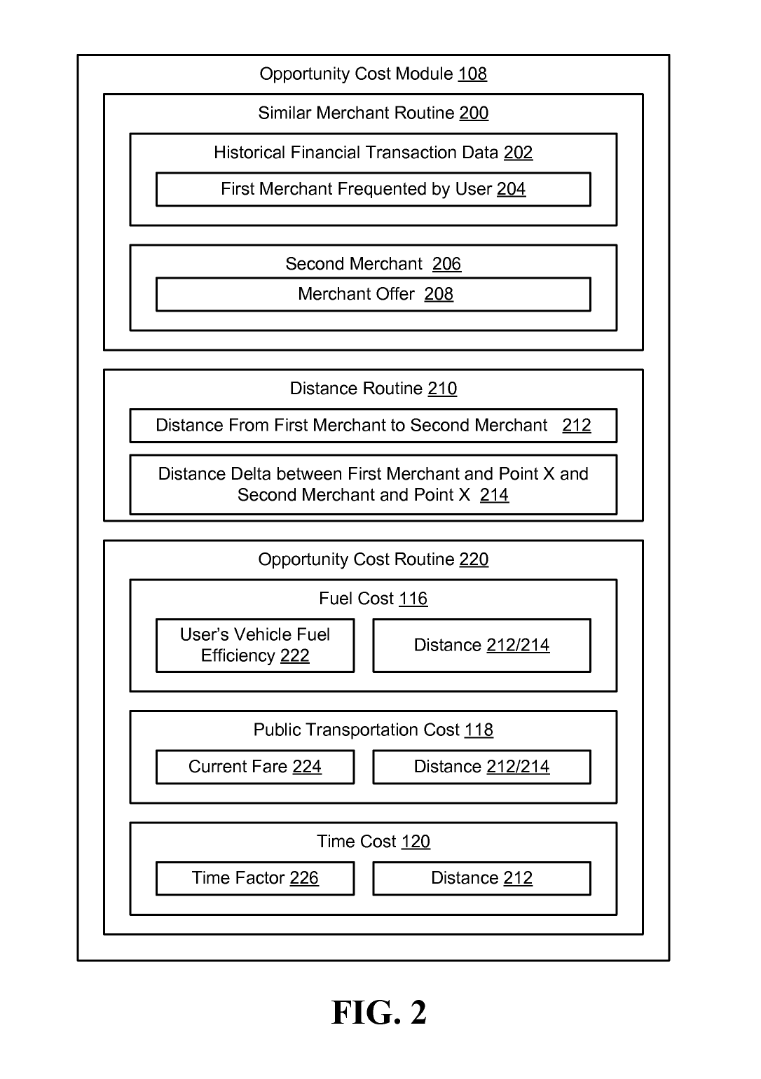

Referring now to FIG. 2, one embodiment of an opportunity cost module 108 is shown. The opportunity cost module 108 includes a similar merchant routine 200 that is configured to determine a merchant frequented by the user that is similar to the merchant associated with the offer. According to specific embodiments, the similar merchant routine 200 may access the user's financial transaction data 202 to identify a first merchant that is frequented by the user and is similar to the second merchant 206 that is associated with the merchant offer 208. The financial transaction data may include purchase history data associated with credit cards, debit cards, checking accounts or the like. For example, if the merchant offer 208 is associated with a clothing store (i.e., the second merchant 206), the similar merchant routine 200 may access the user's historical financial transaction data 202 to identify clothing stores frequented by the user (i.e., the first merchant frequented by the user 204). In those instances in which the user's historical financial transaction data 202 identifies more than one similar merchant, the most frequented merchant, the merchant with a user transaction closest in time and/or the merchant that most closely matches the merchant offer 208 may be identified as the first merchant 204. While in the embodiment shown the similar merchant routine 200 relies on the historical financial transaction data 202 to determine the first merchant frequented by the user 204, in other embodiments other data may accessed to identify the first merchant frequented by the user 204. For example, the user may create a profile that identifies frequented merchants or merchant databases, such as loyalty programs or the like, may provide for identifying frequented merchants.

The opportunity cost module 108 additionally includes a distance routine 210 which, according to certain embodiments, is configured to determine a distance associated with the merchants. In one embodiment the routine is configured to determine the distance 212 from the first merchant 204 to second merchant 206. The distance 212 between the first and second merchants 204, 206 is used to calculate opportunity costs associated with the user accepting the merchant offer 208 associated with the second merchant 206 as opposed to frequenting the first merchant 204. In other embodiments of the invention, the distance routine 210 may determine a first distance between the user's domicile (or user's place of work) and the first merchant 204 and a second distance between the user's domicile (or user's place of work) and the second merchant 206 and calculate the difference between the first and second distances (shown in FIG. 2 as distance delta 214). The distance delta 214 is then used to calculate opportunity cost associated with the user accepting the merchant offer 208 associated with the second merchant 206 as opposed to frequenting the first merchant 204. It should be noted that if the second distance is less than the less than distance (i.e., the user would travel less distance to the merchant associated with the offer than to the first merchant frequented by the user), there may not be a resulting opportunity cost for this particular user. The distance routine 210 may to configured to access an Internet-based map function to determine the distance 212 between the first and second merchants 204, 206, the distance between the user's domicile (or user's place of work) and the first merchant 204 and/or the distance between the user's domicile (or user's place of work) and the second merchant 206. In addition, the Internet-based map function may be implemented to determine the best vehicle route, walking route and/or public transportation route and to provide the distances based on the best vehicle route, walking route and/or public transportation route.

The opportunity cost module 108 additionally includes opportunity cost routine 220 that is configured to determine the opportunity costs associated with the user accepting the merchant offer 208. In specific embodiments of the invention, the opportunity cost routine 220 may be configured to determine a fuel cost 116. The fuel cost 118 may be based on distance 212 or 214 and, in specific embodiments may take into account the user's vehicle fuel efficiency 222. In specific embodiments of the invention, the user's vehicle fuel efficiency 222 may be a static or dynamic parameter. For example, a user may identify the make, model and year of their vehicle and this information may be used to identify the standard mileage per gallon rating for that particular make, model and year of vehicle. In this instance the user's vehicle fuel efficiency 222 is a static parameter that does not vary over time. In other embodiments of the invention, the opportunity cost routine 220 may be in communication with a user's vehicle's on-board performance monitoring system or a database that stores results of the onboard performance monitoring. In such embodiments, the opportunity cost routine 220 may have access to the current vehicle fuel efficiency 222, for example the current vehicle's average mileage per gallon and, in some embodiments this data may be received or obtained from the vehicle in real-time (i.e., at the time when the opportunity cost is calculated). In such instances the user's vehicle fuel efficiency 22 is a dynamic parameter that does vary over time and such variance may be reflected in variance of the opportunity costs 114 incurred by the user and, subsequently, variance in the user-specific merchant offer 124.

In other embodiments of the invention, the opportunity cost routine 220 may be configured to determine a public transportation cost 118. The public transportation cost 118 may be based on the distance 212 or 214 and the identified public transportation route associated with distance 212 or 214. In those embodiments in which a public transportation cost 118 is used to determine opportunity cost 114 in lieu of a fuel cost 116, the user may have identified a preference for public transportation, such as subways, buses, taxis or the like or the opportunity cost module 108 may include a transportation preference routine (not shown in FIG. 2) configured to determine the user's transportation preference based on financial transaction data (e.g., the lack of fuel charges indicates a public transportation preference or the inclusion of public transportation charges/transactions indicates a public transportation preference). In addition to the distance 212 or 214 and/or best route between the distances, the public transportation cost may be determined based on the current fare/rate. The current rate/fare may be current bus fare, subway fare, rapid transit fare, or taxi/cab fare rate applicable in area in which the user lives and/or commutes. In addition to indicating a public transportation preference the user may indicate which specific type of public transportation they prefer or the transportation preference routine may determine which specific public transportation type the user prefers based on financial transaction data. The preferred type of public transportation is used to identify which fare/rate 224 applies for the user in determining the public transportation cost associated with accepting the merchant offer 208.

In other embodiments of the invention, the opportunity cost routine 220 may be configured to determine a time cost 120. The time cost 120 reflects that a value may be placed on the user's time and that additional time may be incurred in travelling to the second merchant 206. As such the time cost 120 may be determined based on the distance 212 or 214, the preferred mode of transportation (e.g., personal vehicle, public transportation, walking, etc.). In addition a time factor 226 may be used to calculate the cost associated with the user's time. It should be noted that in certain embodiments one generic time factor 226 is applied regardless of the user (assumes all users time has equal value), while in other embodiments the time factor may vary from user-to-user based on socio-economic factors, such as the user's income, wealth, location and the like. In those applications in which the time factor 226 varies from user-to-user, a user's time factor may be determined from information provided by the user or determined from financial transaction data, such as account balances, account deposits and the like.

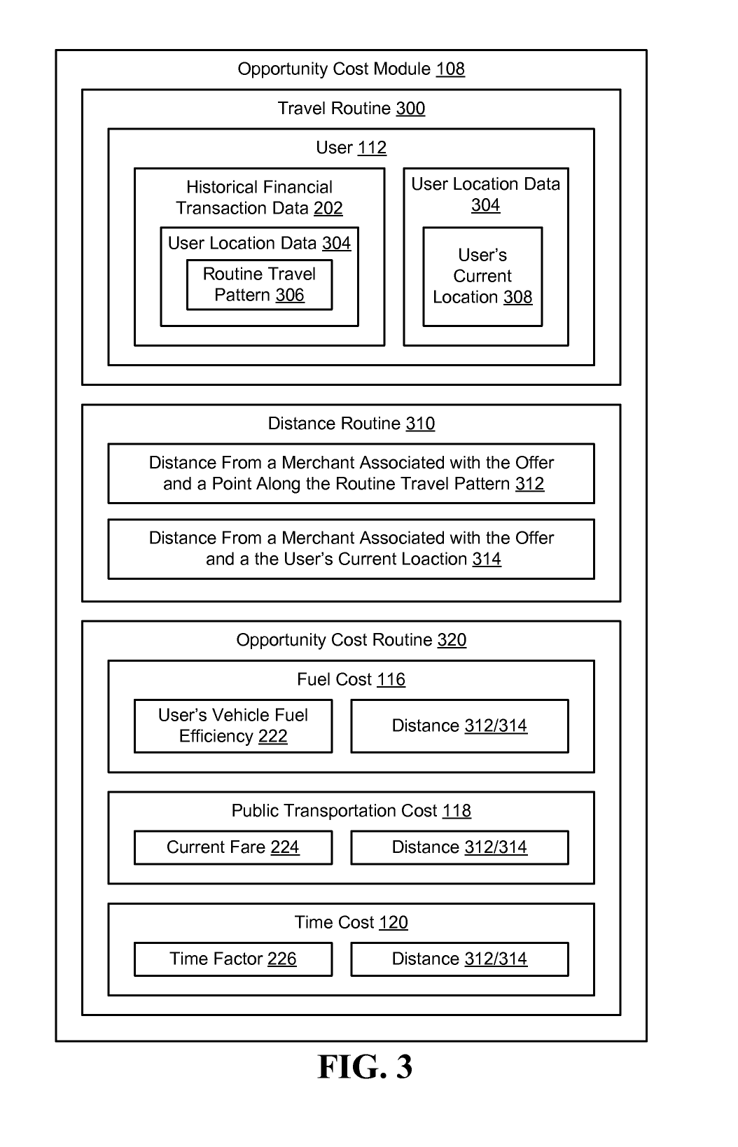

Referring now to FIG. 3, another embodiment of an opportunity cost module 108 is shown. The opportunity cost module 108 includes a travel routine 300 that is configured to determine a routine travel pattern 306 associated with a user 112. A routine travel pattern may be the user's normal commute pattern/route/corridor to the user's place of employment, school, or the like. The travel pattern routine 300 may access the user's historical financial transaction data, such as credit/debit card purchase data or the like, to determine the location of the purchases and, based on the location of the purchases, map out one or more of the user's routine travel patterns 306. Frequent purchases at the same merchant proximate the same time of day are indicative of purchases made along the user's routine travel pattern. For example, purchases made at the same grocery store during the afternoon commute hours or the like. In additional embodiments, the travel routine 300 may rely on user location data 304, such as Global Positioning System (GPS) data provided by a mobile device associated with the user or A GPS device included within the user's vehicle. In specific embodiments of the invention, the user's location data 304 may be used in conjunction with historical financial transaction data 304 to determine the routine travel pattern 306, while in other embodiments the user's location data 304 may be the sole indicator of the routine travel pattern 304. In alternate embodiments the user's location data 304, such as GPS data or the like may be provided in real-time, such that a current GPS location indicates the user's current location 308, the user's current location 308 may be used to determine an opportunity cost. Use of the user's current location 308 in determining an opportunity cost is especially beneficial in instances in which the merchant offer 124 is an “instant” merchant offer only available for an immediate limited time period, (e.g., available for the next 60 minutes or the like).

The opportunity cost module 108 additionally includes a distance routine 210 which, according to certain embodiments, is configured to determine a distance associated with the merchant providing the offer. In one embodiment the routine is configured to determine the distance 312 from the merchant providing the offer and a point along the routine travel pattern (e.g., the point at which the user is likely to divert from the routine travel pattern in order to travel to the merchant). The distance 312 between the merchant providing the offer and a point along the routine travel pattern 306 is used to calculate opportunity costs associated with the user accepting the merchant offer associated with the merchant as opposed to continuing along the routine travel pattern. In other embodiments of the invention in which the travel routine 300 determines the user's current location and the merchant offer is an “instant” offer, the distance routine 310 may determine the distance 314 between the user's current location and the merchant providing the offer. The distance routine 310 may to configured to access an Internet-based map function to determine the distances 312 or 314. In addition, the Internet-based map function may be implemented to determine the best vehicle route, walking route and/or public transportation route and to provide the distances based on the best vehicle route, walking route and/or public transportation route.

The opportunity cost module 108 additionally includes opportunity cost routine 320 that is configured to determine the opportunity costs associated with the user accepting the merchant offer. In specific embodiments of the invention, the opportunity cost routine 320 may be configured to determine a fuel cost 116. The fuel cost 118 may be based on distance 312 or 314 and, in specific embodiments, as previously discussed in relation to FIG. 2 may take into account the user's vehicle fuel efficiency 222. The user's vehicle fuel efficiency 222 may a static parameter that does not vary over time, such as the user's vehicle's estimated mileage per gallon rating, while in other embodiments the user's vehicle fuel efficiency 222 may be a dynamic parameter that varies over time, such as the actual current user's vehicle's mileage per gallon.

In other embodiments of the invention, the opportunity cost routine 320 may be configured to determine a public transportation cost 118. The public transportation cost 118 may be based on the distance 312 or 314 and the identified public transportation route associated with distance 312 or 314. In those embodiments in which a public transportation cost 118 is used in lieu of a fuel cost 116 to determine opportunity cost 114, the user may identify a preference for public transportation, such as subways, buses, taxis or the like or the opportunity cost module 108 may include a transportation preference routine (not shown in FIG. 3) configured to determine the user's transportation preference based on financial transaction data (e.g., the lack of fuel charges indicates a public transportation preference, the inclusion of public transportation charges/transactions indicates a public transportation preference or the like). In addition to the distance 312 or 314 and/or best route between the distances, the public transportation cost may be determined based on the current fare/rate. The current rate/fare may be current bus fare, subway fare, rapid transit fare, or taxi/cab fare rate applicable in the area in which the user lives and/or commutes. In addition to indicating a public transportation preference the user may indicate which specific type of public transportation they prefer or the transportation preference routine may determine which specific public transportation type the user prefers based on financial transaction data. The preferred type of public transportation is used to identify which fare/rate 224 applies for the user in determining the public transportation cost associated with accepting the merchant offer.

In other embodiments of the invention, the opportunity cost routine 220 may be configured to determine a time cost 120. As previously noted, the time cost 120 reflects that a value may be placed on the user's time and that additional time may be incurred in travelling to the merchant providing the offer. As such the time cost 120 may be determined based on the distance 312 or 314, the preferred mode of transportation (e.g., personal vehicle, public transportation, walking, etc.). In addition, as previously discussed, a time factor 226 may be used to calculate the cost associated with the user's time. It should be noted that in certain embodiments one generic time factor 226 is applied regardless of the user (assumes all users time has equal value), while in other embodiments the time factor may vary from user-to-user based on socio-economic factors, such as the user's income, wealth, location and the like.

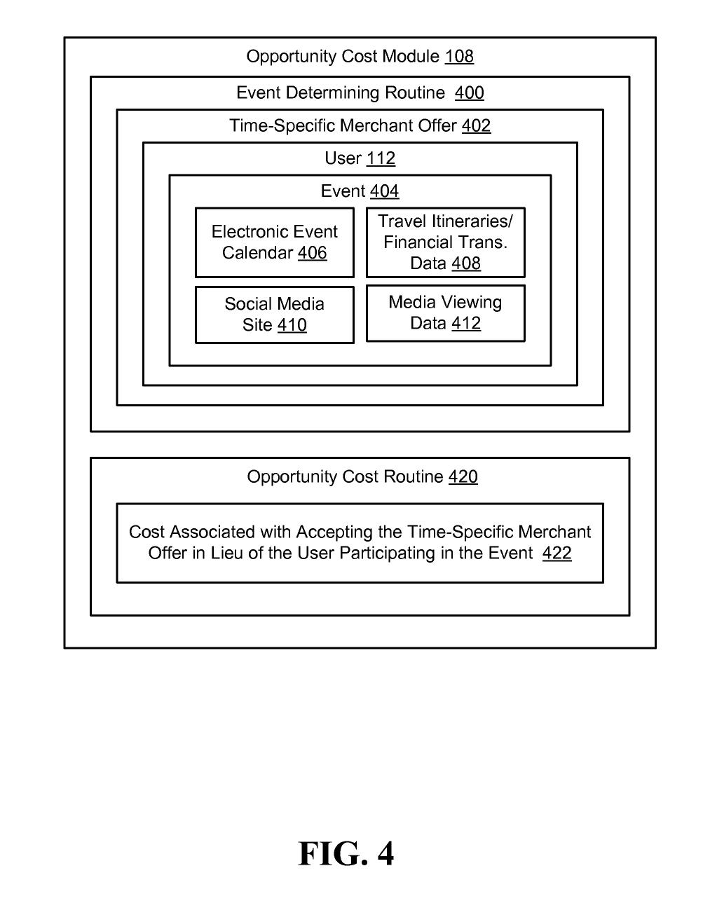

FIG. 4 depicts an alternate embodiment of the opportunity cost module 108, in accordance with further embodiments of the invention. Such embodiments rely on the concept that accepting a merchant offer, specifically a time-dependent merchant offer, in lieu of participating in a planned event has an associated opportunity cost. In this regard, it should be noted that in these embodiments, as well as all other embodiments described herein, merchant offers are not limited to offers provided by brick and mortar retailers or the like but also include offers provided by ticket distribution companies for events. Such offers by ticket distribution companies or the like, for example, offers for concert tickets, sporting event tickets, and the like, are time-specific merchant offers, since the offer is associated with an event occurring at a specific time. If a user presented with such a time-specific offer already has an event planned for that particular time, a merchant offer that includes an additional opportunity cost benefit may serve to entice the user to forego the planned event and accept the offer. In addition, time-specific merchant offers include time-sensitive offers that may available only for a limited time period.

Thus, the opportunity cost module 108 of FIG. 4 includes event determining routine 400 that is operable to determine a scheduled event 404 for a user 112 that coincides with the time associated with a time-specific merchant offer 402. The scheduled 404 may be determined or otherwise identified by accessing one or more databases of information associated with the user. For example, according to specific embodiments, the event determining routine 400 may have access to the user's electronic event calendar 406 available in a personal information manager, such as Microsoft® Outlook® or the like, which stores information, such as time, place and subject matter of a user's upcoming scheduled events. By accessing the user's electronic event calendar 406 the event determining routine 400 can determine if the user has any scheduled events planned that would conflict with the time period for the time-specific merchant offer 402. In other embodiments of the invention, the event determining routine 400 may access one or more of social media sites 410, such as Facebook®, Twitter® associated with the user which may store information related to the user planning to attend upcoming events. Thus, by accessing the user's social media site 410 the event determining routine 400 can determine if the user has any scheduled events planned that would conflict with the time period for the time-specific merchant offer 402.

In additional specific embodiments, the event determining routine 400 may access financial transaction data 408, such a credit/debit account transaction history or the like, to determine travel itineraries or any other information in the transaction data that may indicate an upcoming scheduled event. In still further specific embodiments, the event determining routine 400 may access media viewing data 412, such as television recording service data (e.g., TiVo®, Digital Video Recorder (DVR) service or the like) to determine the user's television viewing patterns. For example, the event determining routine 400 determines that a user regularly watches a television series on a weekly basis at a specific time (i.e., the broadcast time for the show as opposed to recording the show for later viewing). Thus, by accessing the user's financial transaction data 408 or media usage data 412 the event determining routine 400 can determine if the user has any scheduled events or media viewing planned that would conflict with the time period for the time-specific merchant offer 402.

The opportunity cost module 108 additionally includes opportunity cost routine 420 that is configured to determine an opportunity cost 422 associated with the user accepting the time-specific offer in lieu of user participating in their planned event. In this regard, the opportunity cost, which is subsequently reflected in the merchant offer by an additional benefit/discount, is indicative of the value placed by the user on the planned event and what it would take in terms of an enticement for the user to forego the planned event and accept the time-specific merchant offer. In specific embodiments of the invention events may be categorized in terms of relative importance, such that, the opportunity cost 422 varies based on the type of planned event. For example, a higher opportunity cost may be envisioned for foregoing a scheduled trip than for foregoing viewing a television show. In such embodiments, the user may assign categories or levels of importance to types of events or the overall merchant offer program may pre-configure the categories and/or levels of importance. In addition, the determination of opportunity cost 422 may be user-specific taking into account other known socio-economic or personality characteristics of the user. For example, the opportunity cost assigned to a casual baseball fan to forego attending a baseball game may be lower than the opportunity assigned to an ardent baseball fan.

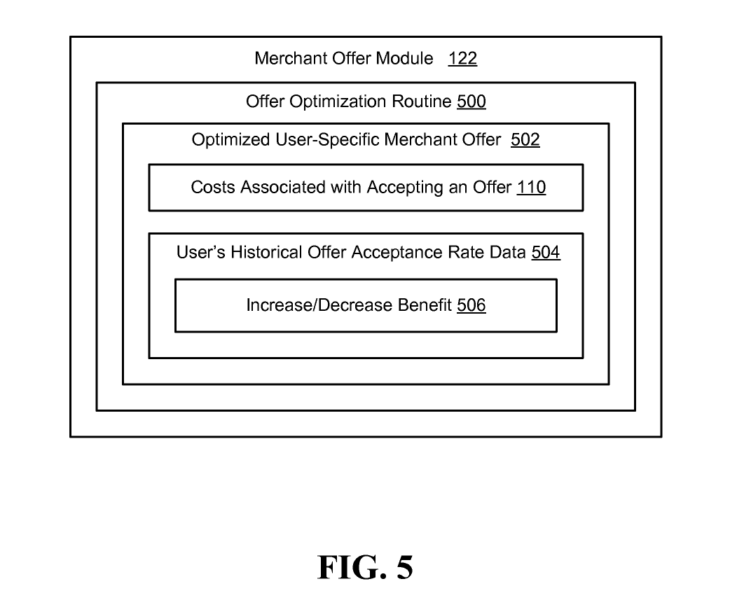

Referring to FIG. 5 depicted is a block diagram of a merchant offer module 122, according to specific embodiments of the present invention. The merchant offer module 122 includes offer optimization routine 500 that is configured to optimize merchant offers on a user-specific basis. According to specific embodiments of the invention, the offer optimization routine is configured to generate optimized user-specific merchant offers 502 based on the costs associated with accepting an offer 110 (i.e., the opportunity costs). For example, as previously explained the costs associated with accepting an offer 110 may include, but are not limited to, fuel costs 116, public transportation costs 118, time costs 120 and other costs 122 (shown in FIG. 1). In this regard, optimization provides for increasing the benefit provided in the merchant offer to offset the costs that the user will incur in accepting the offer 110. The offset may come in the form of an increase in the dollar-off amount, an increase in the percentage offer, a rebate, loyalty program credit, an ancillary benefit (e.g. a free product offer or the like) or the like.

In additional embodiments of the invention, the offer optimization routine 500 is configured to generate optimized user specific merchant offers 502 based on the user's historical offer acceptance rate data 504. The user's historical offer acceptance rate data 504 may include the rate or percentage of overall offers that the user has accepted, the rate or percentage of offers that the user has accepted for a specific offer category (e.g., entertainment, fine dining, fast-food dining, etc.), the rate or percentage of offers that the user has accepted for a specific merchant or brand and the like. Based on the user's historical acceptance rate data 504 the user-specific merchant offer may optimized to increase or decrease the benefit 506 provided to the user. For example, if the user has shown a high rate of accepting offers, or offers for a specific offer category or specific merchant, it is likely that the user may accept the current offer and, as such, either no additional benefit may be warranted or the offer may be decreased (e.g., less of a benefit offered). Decreasing the offer may include, but ids not limited to, decreasing the dollar-off amount, decreasing the percentage off or the like. Conversely, if the user has shown a low rate of accepting offers, or offers for a specific offer category or specific merchant, it is unlikely that user may accept the current offer and, as such, the offer may optimized to reflect an increased the benefit. The increased benefit, may include but is not limited to, increase in the dollar-off amount, an increase in the percentage offer, a rebate, loyalty program credit, an ancillary benefit (e.g. a free product offer or the like) or the like. In specific embodiments, the optimization routine 500 may use the user's historical offer acceptance rate 504 to determine the optimal merchant offer amount/discount (i.e., the offer amount/discount or benefit at which the user will or is prone to accept the offer).

It should also be noted that while the optimization routine 500 may be configured in some embodiments to increase the benefit for user's with a lower historical offer acceptance rate, in other embodiments, for specific offers or offers in general, the optimization routine 500 may be configured to increase the benefit for user's with a higher historical offer acceptance rate in order to insure that the offer is accepted (for example, if the merchant is offering goods/service they are having difficulty selling or goods/service which are abut to expire.)

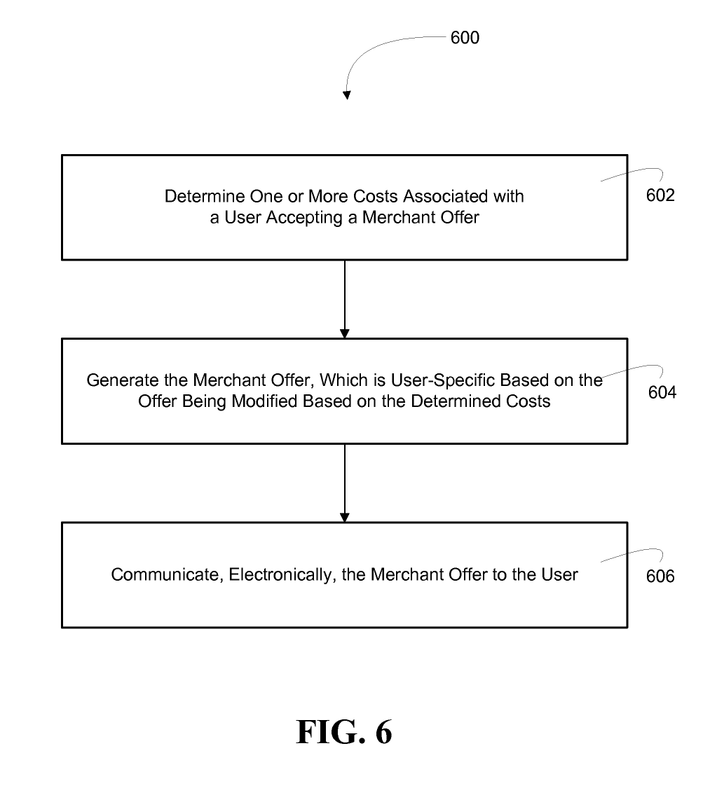

Referring to FIG. 6 a flow diagram is presented of a method 600 for providing merchant offers, in accordance with embodiments of the present invention. At Event 602, one or more costs associated with a user accepting a merchant offer are determined. The one or more costs may include, but are not limited to, a transportation cost (e.g., fuel costs, public transportation costs or the like), a time cost or any other cost associated with accepting the offer.

In one specific embodiment of the method, the one or more costs associated with accepting the offer are determined by identifying a first merchant that has been frequented by the user and provides goods or services similar to the second merchant associated with the offer. In such embodiments, the first merchant may be identified by accessing the user's historical financial transaction data (e.g., debit/credit transaction history or the like) to determine which merchants the user has previously made purchases at. Once the first merchant has been identified, the method further includes determining a distance associated with the first and second merchants. The distance may be the distance between the first and second merchants and/or the difference in distances between the distance between the user's domicile or place of work and the first merchant versus the distance between the user's domicile or place of work and the second merchant. The distance may be defined in terms of a user vehicle distance, a public transportation distance and/or a walking distance. The distance may be determined by accessing a network entity, such as an Internet-based mapping service or the like. Once the distance is determined, one or more of a fuel cost, a public transportation cost and/or a time cost associated with the distance is determined.

In specific embodiments in which determining the costs associated with a user accepting a merchant offer includes determining a fuel cost the fuel costs may be based on the fuel efficiency of the user's vehicle. Such fuel efficiency may be based on the make, model, year of the vehicle and the known miles per gallon rating and/or the fuel efficiency may be based on actual fuel efficiency data provided by the vehicle's electronic system. In such embodiments in which fuel efficiency data is provided by the user's vehicle, the data may be provided in real-time, such that the merchant offer, which reflects an increased benefit based on the costs associated with accepting the offer, is based on the user's vehicle's current fuel efficiency.

In other specific embodiments of the method, the one or more costs associated with accepting the offer are determined by identifying a routine travel pattern associated with the user. A routine travel pattern or travel corridor includes a regular commute pattern (e.g., the way to and/or from work, school or the like). In one embodiment of the method, the routine travel pattern may be identified based on the user's financial transaction data. The financial transaction data, such as debit/credit purchase data, may indicate purchases that the user has made along the routine travel pattern, thereby allowing for at least a proximate gauge of the user's routine travel pattern. In additional, embodiments of the method, the routine travel pattern may be determined, either alone or in unison with financial transaction data, based on location data associated with the user (e.g., GPS data provided by a user's mobile device or a user's vehicle).

Once the routine travel pattern has been identified, one or more of a fuel, cost, a public transportation cost and/or a time cost associated with the user deviating from the routine travel pattern is determined. In such embodiments the method may include determining the distance between the merchant associated with merchant offer and a point along the routine travel path. The distance may be defined in terms of a user vehicle distance, a public transportation distance and/or a walking distance. The distance may be determined by accessing a network entity, such as an Internet-based mapping service or the like. As previously noted, the determination of the fuel cost may be based on the user's vehicle's fuel efficiency, which me a static fuel efficiency miles per gallon rating or a dynamic action fuel efficiency provided by the vehicle's diagnostics.

In other specific embodiments of the method, the one or more costs associated with the user accepting a time-specific merchant offer may include costs associated with the user accepting the time-specific merchant offer in lieu of participating in another event planned by the user during a time period for the time-specific event. The time-specific merchant offer may be for an entertainment event, such as a sporting event, a concert, or the like or for any other offer that is only valid for a specific period of time, wherein the specific period of time is typically less than a day. In such embodiments the planned event may be determining by accessing an event database associated with the user. The event database may include, but is not limited to, an electronic event calendar (e.g., Microsoft® Outlook®), travel itineraries found in financial transaction data, a social media network or electronic media (e.g., television, webcast) usage data.

Referring again to FIG. 6, at Event 604 a user-specific merchant offer is generated, such that the offer is “user-specific” based on the determined costs associated with accepting the offer. In this regard, the generated user-specific merchant offer provides for additional benefits to compensate the user for the costs associated with accepting the offer. The additional benefits may be in the form of an increased percentage-off, an increased currency amount-off, a rebate, loyalty program points, free product/service or the like. The “user-specific” nature of the offer indicates each merchant offer will vary based on the user's unique costs associated with accepting the offer. In specific embodiments of the offer, generating the offer may also include optimizing the merchant offer. Optimizing the offer may include increasing or decreasing the benefit provided in the offer. In certain embodiments, such optimization provides for setting the discount level at a lowest point possible that will affect the user to accept the user. For example, if it is perceived that the user would not accept a ten-percent discount but would accept a twelve-percent discount, than optimization would result in setting the discount as twelve-percent. In specific embodiments, the user's historical offer acceptance rate may used to optimize the merchant offer, such that a low offer acceptance may result in a higher discount/benefit to entice the user to accept, while a high offer acceptance rate may result in setting the discount/benefit lower, since the user has displayed a propensity to accept.

At Event 606, the user-specific merchant offer is communicated to the user. The merchant offer may be communicated to the user via a user preferred communication mechanism, such as electronic mail (email), Short Message Service (SMS)/text, social media posting or the like.

Thus, present embodiments disclosed in detail above provide for systems, apparatus, methods and computer program products that provide customized offers that reflect the user's opportunity cost associated with accepting the offer. In this regard, the customized offers may include additional savings, in terms of an additional discount, percentage-off or other incentive, to account for the user's specific transportation costs, time costs and the like. In additional embodiments the customization accounts for the user's propensity for accepting offers and adjusts the offer discount, percentage-off or other incentive based on their historical acceptance rates. By customizing the offers to account for opportunity costs, and in some embodiments historical offer acceptance rates, the present invention serves to increase offer acceptance, thereby benefiting the program provider and/or the merchants offering the offers/deals.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing merchant offers, the method comprising:
determining, via a computing device processor, one or more costs associated with a user accepting a merchant offer;
generating, via a computing device processor, the merchant offer that is user-specific based on the determined costs; and
communicating, via a computing device, the merchant offer to the user.

2. The method of claim 1, wherein determining further comprises determining, via a computing device, at least one of a transportation cost or a time cost associated with the user accepting the merchant offer.

3. The method of claim 1, wherein determining further comprises:
determining, via a computing device processor, a first merchant that is routinely frequented by the user, wherein the first merchant provides products or services similar to a second merchant associated with the merchant offer;
determining, via computing device processor, a distance between the first merchant and the second merchant; and
determining, via a computing device processor, one or more of a fuel cost, a public transportation cost or a travel time cost associated with the distance.

4. The method of claim 3, wherein determining the first merchant further comprises determining, via a computing device, the first merchant based on historical financial transaction data associated with the user.

5. The method of claim 3, wherein determining the fuel cost further comprises determining, via the computing device, the fuel costs based on fuel efficiency of a vehicle driven by the user.

6. The method of claim 1, wherein determining further comprises:
determining, via a computing device, a routine travel pattern associated with the user; and
determining, via a computing device, one or more of a fuel cost, a public transportation cost or a travel time cost associated with the user deviating from the routine travel pattern.

7. The method of claim 6, wherein determining the routine travel pattern further comprises determining, via the computing device, the routine travel pattern based on financial transaction data associated with the user.

8. The method of claim 7, wherein determining the routine travel pattern further comprises determining, via the computing device, the routine travel pattern based on location data associated with the user.

9. The method of claim 6, wherein determining one or more cost further comprises:
determining, via computing device processor, a distance between a merchant associated with the merchant offer and a point along the routine travel pattern; and
determining, via a computing device processor, the fuel cost, the public transportation cost or the travel time cost associated with the distance.

10. The method of claim 9, wherein determining the fuel cost further comprises determining, via the computing device, the fuel cost based on fuel efficiency of a vehicle driven by the user.

11. The method of claim 1, wherein determining further comprises determining, via a computing device processor, the one or more costs associated with the user accepting a time-specific merchant offer, wherein one of the costs is associated with the user accepting the time-specific merchant offer in lieu of another event planned by the user during a time period for the time-specific merchant offer.

12. The method of claim 11, further comprising determining, via a computing device processor, the event based on accessing one or more of an electronic event calendar associated with the user, travel itineraries associated with the user, a social network site associated with the user or historical electronic media usage data associated with the user.

13. The method of claim 1, wherein generating further comprises generating, via a computing device processor, an optimal user-specific merchant offer that is optimized based at least in part on the determined costs.

14. The method of claim 13, wherein generating the optimal user-specific merchant offer further defines the optimal user-specific merchant offer as a lowest discount that results in the user accepting the merchant offer.

15. The method of claim 13, wherein generating the optimal user-specific merchant offer further comprises generating, via the computing device processor, the optimal user-specific merchant offer based on a historical offer acceptance rate of the user.

16. An apparatus for providing merchant offers, the method comprising:
a computing device including a memory and at least one processor in communication with the memory;
an opportunity cost module stored in the memory, executable by the processor and configured to determine one or more costs associated with a user accepting a merchant offer;
a merchant offer module stored in the memory, executable by the processor and configured to generate the merchant offer that is user-specific based on the determined costs and initiate communication of the merchant offer to the user.

17. The apparatus of claim 16, wherein the opportunity cost module is further configured to determine at least one of a transportation cost or a time cost associated with the user accepting the merchant offer.

18. The apparatus of claim 16, wherein the opportunity cost module further comprises:
a similar merchant routine configured to determine a first merchant that is routinely frequented by the user and is similar to a second merchant associated with the merchant offer;
a distance routine configured to determine a distance between the first merchant and the second merchant; and
an opportunity cost routine configured to determine one or more of a fuel cost, a public transportation cost or a travel time cost associated with the distance.

19. The apparatus of claim 18, wherein the similar merchant routine is further configured to determine the first merchant based on historical financial transaction data associated with the user.

20. The apparatus of claim 18, wherein the opportunity cost routine is further configured to determine the fuel costs based on fuel efficiency of a vehicle driven by the user.

21. The apparatus of claim 16, wherein the opportunity cost module further comprises:
a travel pattern routine configured to determine a routine travel pattern associated with the user; and
an opportunity cost routine configured to determine one or more of a fuel cost, a public transportation cost or a travel time cost associated with the user deviating from the routine travel pattern.

22. The apparatus of claim 21, wherein the travel pattern routine is further configured to determine the routine travel pattern based on financial transaction data associated with the user.

23. The apparatus of claim 22, wherein the travel pattern routine is further configured to determine the routine travel pattern based on location data associated with the user.

24. The apparatus of claim 21, wherein the opportunity cost routine is further configured to:
determine a distance between a merchant associated with the merchant offer and a point along the routine travel pattern; and
determine the fuel cost, the public transportation cost or the travel time cost associated with the distance.

25. The apparatus of claim 24, wherein the opportunity cost routine is further configured to determine the fuel cost based on fuel efficiency of a vehicle driven by the user.

26. The apparatus of claim 16, wherein the opportunity cost module is further configured to determine the one or more costs associated with the user accepting a time-specific merchant offer, wherein one of the costs is associated with the user accepting the time-specific merchant offer in lieu of another event planned by the user during a time period for the time-specific merchant offer.

27. The apparatus of claim 26, further comprising an event determining routine configured to determine the event based on accessing one or more of an electronic event calendar associated with the user, travel itineraries associated with the user, a social network site associated with the user or historical electronic media usage data associated with the user.

28. The apparatus of claim 16, wherein the merchant offer module further comprises an offer optimization routine configured to optimize the user-specific merchant offer based at least in part on the determined costs.

29. The apparatus of claim 28, wherein the offer optimization routine is further configured to optimize the user-specific merchant offer based on a lowest discount that results in the user accepting the merchant offer.

30. The apparatus of claim 28, wherein the offer optimization routine is further configured to optimize the user-specific merchant offer based on a historical offer acceptance rate of the user.

31. A computer program product, the computer program product comprising a non-transitory computer-readable medium having computer-executable instructions to cause a computer to implement the steps of:
determining one or more costs associated with a user accepting a merchant offer;
generating the merchant offer that is user-specific based on the determined costs; and
communicating the merchant offer to the user.

32. The computer program product of claim 31, wherein the step of determining further comprises determining at least one of a transportation cost or a time cost associated with the user accepting the merchant offer.

33. The computer program product of claim 31, wherein the step of determining further comprises:
determining a first merchant that is routinely frequented by the user, wherein the first merchant provides products or services similar to a second merchant associated with the merchant offer;
determining a distance between the first merchant and the second merchant; and
determining one or more of a fuel cost, a public transportation cost or a travel time cost associated with the distance.

34. The computer program product of claim 33, wherein the step of determining the first merchant further comprises determining the first merchant based on historical financial transaction data associated with the user.

35. The computer program product of claim 33, wherein the step of determining the fuel cost further comprises determining the fuel costs based on fuel efficiency of a vehicle driven by the user.

36. The computer program product of claim 31, wherein the step of determining further comprises:
determining a routine travel pattern associated with the user; and
determining one or more of a fuel cost, a public transportation cost or a travel time cost associated with the user deviating from the routine travel pattern.

37. The computer program product of claim 36, wherein the step of determining the routine travel pattern further comprises determining the routine travel pattern based on financial transaction data associated with the user.

38. The computer program product of claim 37, wherein the step of determining the routine travel pattern further comprises determining the routine travel pattern based on location data associated with the user.

39. The computer program product of claim 36, wherein the step of determining one or more further comprises:
determining a distance between a merchant associated with the merchant offer and a point along the routine travel pattern; and
determining the fuel cost, the public transportation cost or the travel time cost associated with the distance.

40. The computer program product of claim 39, wherein the step of determining the fuel cost further comprises determining the fuel cost based on fuel efficiency of a vehicle driven by the user.

41. The computer program product of claim 31, wherein the step of determining further comprises determining the one or more costs associated with the user accepting a time-specific merchant offer, wherein one of the costs is associated with the user accepting the time-specific merchant offer in lieu of another event planned by the user during a time period for the time-specific merchant offer.

42. The computer program product of claim 41, further comprising the step of determining the event based on accessing one or more of an electronic event calendar associated with the user, travel itineraries associated with the user, a social network site associated with the user or historical electronic media usage data associated with the user.

43. The computer program product of claim 31, wherein the step of generating further comprises generating an optimal user-specific merchant offer that is optimized based at least in part on the determined costs.

44. The computer program product of claim 43, wherein the step of generating the optimal user-specific merchant offer further defines the optimal user-specific merchant offer as a lowest discount that results in the user accepting the merchant offer.

45. The computer program product of claim 43, wherein the step of generating the optimal user-specific merchant offer further comprises generating the optimal user-specific merchant offer based on a historical offer acceptance rate of the user.
